(19) United States
(12) Patent Application Publication
(10) Pub. No.: US 2025/0118933 A1
(43) Pub. Date: Apr. 10, 2025

(54) TECHNIQUES TO IMPROVE SIGNAL INTEGRITY PERFORMANCE FOR A 3-CONNECTOR DESIGN

(71) Applicant: Intel Corporation, Santa Clara, CA (US)

(72) Inventors: Kai XIAO, Portland, OR (US); Diego Mauricio CORTES HERNANDEZ, Beaverton, OR (US); Luz Karine SANDOVAL GRANADOS, Zapopan (MX); Jingbo LI, Portland, OR (US); Raul ALCALA ARREOLA, Zapopan (MX); Quresh BOHRA, San Jose, CA (US); Jose Manuel CANTOR GONZALEZ, Zapopan (MX); Fabio RUIZ MOLINA, Zapopan (MX); Carlos Guillermo TERRIQUEZ ARIAS, Zapopan (MX); Adriana LOPEZ INIGUEZ, Zapopan (MX)

(21) Appl. No.: 18/989,657

(22) Filed: Dec. 20, 2024

(51) Int. Cl. H01R 13/6471; H01R 12/70; H01R 12/71; H01R 12/75; H01R 13/04

(52) U.S. Cl. CPC H01R 13/6471; H01R 12/7076; H01R 12/712; H01R 12/75; H01R 13/04; H01R 2201/06

(57) ABSTRACT

Examples include techniques to improve signal integrity performance for a 3-connector design. The techniques include mounting a socket connector to a first side of a hot swap backplane such that pins of the first socket connector mirror pins of a second socket connector mounted to a second side of the hot swap backplane. The mirrored pins associated with routing data signals. The socket connector having a housing configured to receive a first plug connector of a cable assembly that has a second plug connector coupled with a processor baseboard socket connector.

### TECHNICAL FIELD

Descriptions are generally related to techniques for improving signal integrity performance for a 3-connector design implemented in a backplane topology.

### BACKGROUND

A 3-connector cabling topology, hereinafter referred to as a 3-connector design, can be one example of a type of backplane topology for a computing platform (e.g., a server). A 3-connector design is often used in data centers to support multiple disk drives (e.g., solid state drives) as this type of backplane topology can be arranged to include clock buffer, enclosure management and hot-plugging functionalities. A 3-connector design includes 3 connectors, a cable assembly and a printed circuit board (PCB). The PCB included in this 3-connector design can be referred to as a hot swap backplane (HSBP).

### BRIEF DESCRIPTION OF THE DRAWINGS

FIG. 1 illustrates an example computing platform system.

FIG. 2 illustrates an example 3-connector design.

FIG. 3 illustrates an example alignment scheme.

FIG. 4 illustrates an example cable configuration.

FIG. 5 illustrates an example socket connector layout.

FIG. 6 illustrates an example socket connector pinout arrangement.

FIG. 7 illustrates an example cable receive/transmit signal pinout.

FIG. 8 illustrates an example process flow for a 3-connector design.

### DETAILED DESCRIPTION

Increasing data rates required for various types of devices arranged to couple with a backplane topology for a computing platform and use of pulse amplitude modulation with four levels (PAM-4) to transmit data signals can present a challenge from a system and signal integrity point of view when coupling devices within the computing platform via a 3-connector design. For example, 3 connectors, a cable assembly and an HSBP arranged to transmit or receive signals via a signal channel can increase a number of discontinuities in a data signal channel and lead to signal channel losses, crosstalk, and/or reflections.

A 3-connector design is a popular type of backplane topology associated with devices such as, but not limited to, storage devices arranged to operate using communication channels or links according to a Peripheral Component Interconnect Special Interest Group (PCI-SIG) specification such as PCI Express Base Specification, Revision 6.2, originally published in February 2024, herein after referred to as “PCIe 6.x” and/or other earlier or later revisions of the PCIe specification, for example, PCIe 5.x or PCIe 7.x, 8.x, etc. In some examples, storage devices arranged to operate communication channels or links according to PCIe 5.x or PCIe 6.x can also be referred to as PCIe Gen 5 or PCIe Gen 6 storage links. A 3-connector design can include three major components of a baseboard for a central processing unit (CPU), a cable assembly and an HSBP. Typically, a 3-connector design has three connectors, four via transitions, three segments of routing, and one cable assembly. These components of a 3-connector design can result in a complicated and difficult backplane topology from a signal integrity point of view.

Current 3-connector designs typically need about 6 inches of PCB wire/trace routing on the baseboard for routing a storage link to the CPU and 3 inches of PCB wire/trace routing for routing the storage link between socket connectors coupled to an HSBP to support common data center configurations for each disk drive to couple with a CPU through the storage link. The total needed routing for each storage link between a disk drive and the CPU is about 9 inches and a cable assembly coupled between the baseboard and the HSBP is about 20 inches for current 3-connector designs implemented in data centers. Based on best-known circuit and platform assumptions, a maximum PCB trace routing length for a PCIe Gen 6 storage link using ultra-low-loss PCB materials (for both the baseboard and HSBP) is around 7 inches. So current 3-connector designs have PCB trace routing lengths that can be 2 inches too long to support PCIe Gen 6 storage link requirements. Although a 2 inch gap does not seem too large, it can be very expensive to close this 2 inch gap using such techniques that include use of a re-timer device or extremely low-loss PCB materials. A preferred option to close the 2 inch gap would be to optimize a 3-connector design without using an additional active device (e.g., re-timer device) or very expensive PCB materials. Extensive optimizations have been made with current 3-connector designs at the baseboard in terms of socket connector placement in relation to a board layout. However, there may be little to no room left for further baseboard optimizations without fundamental changes of an overall baseboard architecture and/or of form factors of surrounding components, such as CPU, dual in-line modules (DIMMs), voltage regulators, PCIe connectors, etc. However, as described in this disclosure, example techniques to improve signal integrity performance for a 3-connector design through changes to the cable assembly and socket connectors arranged to couple to the HSBP can substantially reduce or eliminate PCB trace routing through the HSBP for a data signal channel routed between pins of connectors on either side of the HSBP. These changes, as describe below, result in a new 3-connector design that can meet PCIe Gen 6 and/or possibly later PCI Gen storage link requirements without using additional active devices and/or expensive PCB materials in the baseboard or the HSBP.

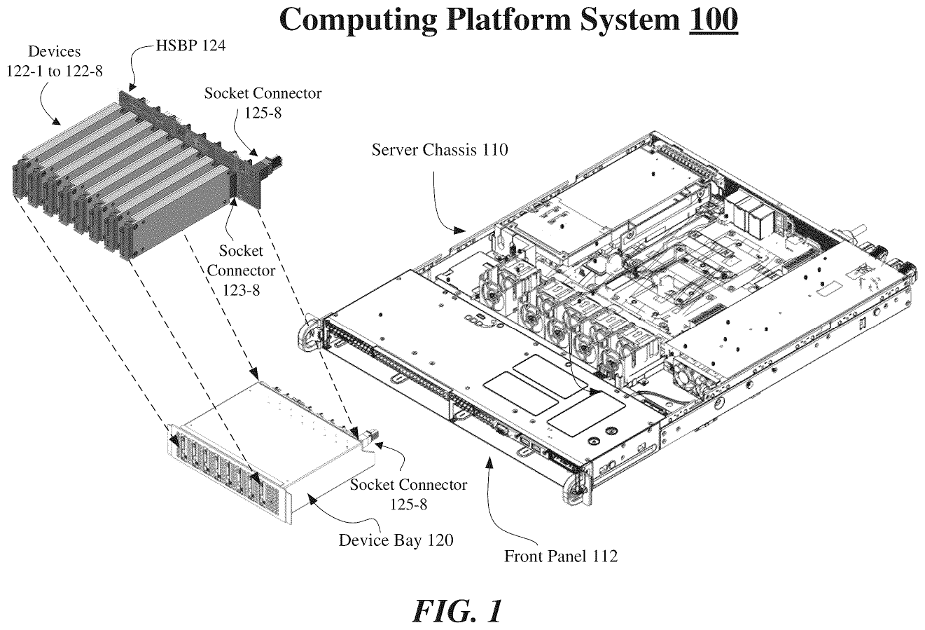

FIG. 1 is a block diagram of an example computing platform system 100. As shown in FIG. 1, computing platform system 100 includes a server chassis 110 that can be arranged to house a device bay 120 inserted in at least a portion of a front panel 112 of server chassis 110. Also, according to some examples, device bay 120 can be configured to include a hot swap back plane (HSBP) 124. For these examples an expanded view of devices 122-1 to 122-8 coupled to HSBP 124 is shown in FIG. 1. The expanded view also shows a socket connector 123-8 from among socket connectors 123-1 to 123-8 as one example of how device 122-8 from among devices 122-1 to 122-8 can couple with a first side of HSBP 124 and a socket connector 125-8 from among socket connectors 125-1 to 125-8 that can be arranged to couple with a first plug connector on an end of a cable assembly that can couple with a CPU or processor baseboard socket connector (not shown) on another end of the cable assembly through a second plug connector.

According to some examples, devices 122-1 to 122-8 can be disk drives to include, but are not limited to, solid state drives (SSDs), to couple with one or more CPUs housed in server chassis 110. Devices 122-1 to 122-8, for example, can be arranged in an enterprise and data center SSD form factor (EDSFF) to couple to respective socket connectors on HSBP 124 such as socket connector 123-8. For these examples, computing platform system 100 can be deployed in a data center as part of a data storage service. Examples are not limited to data center deployments or data storage services. Also, examples are not limited to devices 122-1 to 122-8 being disk drives. Other examples can include other types of devices that can be configured to have edge connectors that can be inserted into a socket connector on HSBP 124 such as, but not limited to, a graphic processing unit (GPU) accelerator device or other types of processor accelerator devices that may require high data rates for signals routed between a device and a CPU or processor housed in server chassis 110 using a 3-connector design.

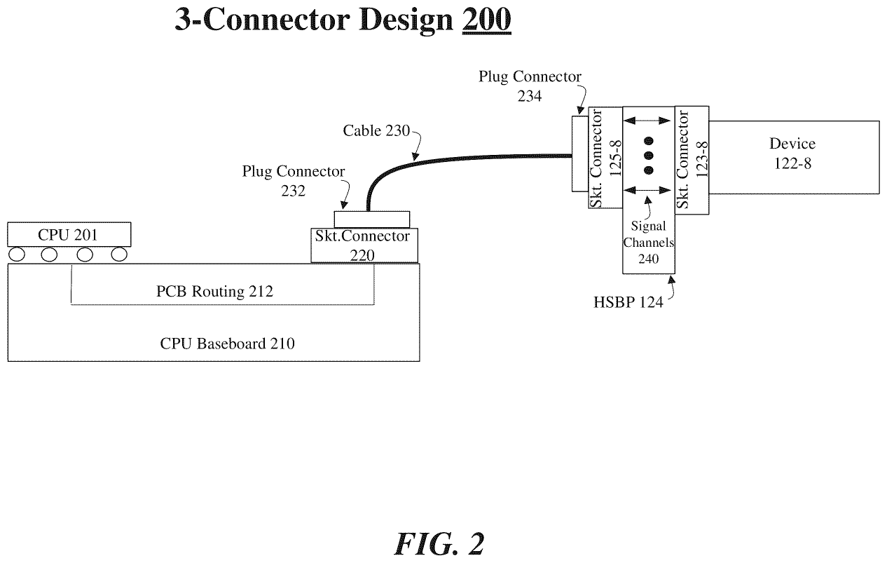

FIG. 2 illustrates an example 3-connector design 200. In some examples, as shown in FIG. 2, 3-connector design 200 has a CPU 201 (e.g., housed in server chassis 110) arranged on a CPU baseboard 210 that has a PCB routing 212 between CPU 201 and socket connector 220. Also, as shown in FIG. 2, a cable assembly 230 can couple socket connector 220 with socket connector 125-8. A first plug connector of cable assembly 230 is shown in FIG. 2 as plug connector 232 to couple with socket connector 220 and a second plug connector of cable assembly is shown in FIG. 2 as plug connector 234 to couple with socket connector 125-8. For these examples, receive (Rx) and transmit (Tx) pins of socket connector 125-8 can be configured to mirror Rx and Tx pins of socket connector 123-8 such that Rx/Tx data signal channels included in signal channels 240 can be routed through HSBP 124 between these socket connectors without a need for PCB trace routing.

In current 3-connectors designs, socket or receptable connectors can be placed on two sides of an HSBP. The types of socket connectors used on either side can be selected independently and placed on either side with an offset. Typically, to connect all signal paths or channels between the two offset socket connectors, 3 inches of PCB trace routing is needed with two transition vias through the HSBP for each data signal channel. Due to rigidity requirements to allow for insertion of multiple devices in socket connectors on the HSBP, the HSBP can be a relatively thick PCB. For high-speed signal designs (e.g., for PCIe Gen 6 links), at least one of the two transition vias need to be back drilled for stub effect mitigation. PCB trace routing and back drilled vias on the HSBP increase channel loss, reduce signal integrity, increase signal reflections, and contribute to the above-mentioned 2 inch gap to meeting PCIe Gen 6 link requirements using current 3-connector designs.

According to some examples, where new 3-connector design 200 can be designed to couple PCIe Gen 6 links between CPU 201 and a device from among devices 122-1 to 122-8, surface mount technology (SMT) can be used to mount socket connector 125-8 and socket connector 123-8 to HSBP 124 and to mount socket connector 220 to CPU baseboard 210. For these examples, socket connectors 220, 125-8, and 123-8 can be high-density SMT connectors designed according to one or more Small Form Factor—Technology Affiliate (SFF-TA) specifications published by the Storage Networking Industry Association (SNIA). Plug connectors 232 and 234 of cable assembly 230 can also be designed according to one or more SFF-TA specifications in order to mate or physically couple with respective socket connectors 220 and 123-8. Device 122-8 can be configured to include an edge connector (not shown) that can also be designed according to one or more SFF-TA specifications in order to mate or physically couple with socket connector 123-8. For example, socket connectors 220 and 125-8 and plug connectors 232 and 234 of cable assembly 230 can be configured according to SFF-TA-1016, “Internal Unshielded High Speed Connector System”, Rev 1.3, published in November 2024. Meanwhile socket connector 123-8 and the edge connector of device 122-8 can be configured according to SFF-TA-1002, “Protocol Agnostic Multi-Lane High Speed Connector”, Rev 1.5, published in April 2024 or SFF-TA-1020, “Cables and Connector Variants Based on SFF-TA-1002, Rev 1.1, published in November 2023. SFF-TA-1016, SFF-TA-1002, or SFF-TA-1020 can be particularly popular in data center or enterprise server designs. In some examples, use of these standardized connectors in a new 3-connector design can make it possible to select, place and set a pinout arrangement of socket connectors on an HSBP such as socket connectors 125-8 and 123-8 on HSBP 124 that can allow for a mirrored pin configuration that substantially reduce or eliminate PCB trace routing of signal channels 240 through HSBP 124 and enable, for example, PCIe Gen 6 link requirements to be met for this new 3-connector design 200.

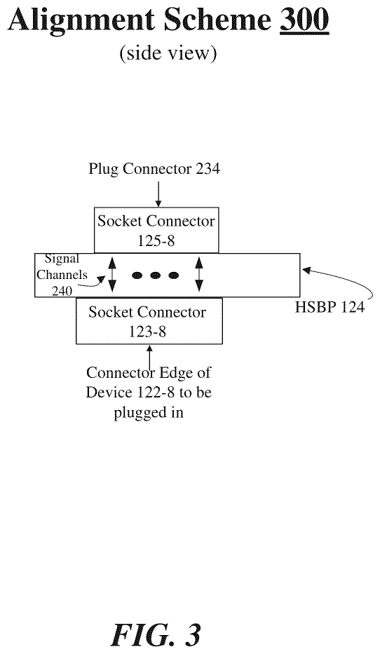

FIG. 3 illustrates an example side view 300. In some examples, side view 300 is a side view of a portion of 3-connector design 200 that shows an alignment of socket connectors 125-8 and 123-8 on opposing sides of HSBP 124. For these examples, socket connector 125-8, as mentioned above, can be arranged to couple or mate with plug connector 234 of cable assembly 230 and socket connector 123-8 can be arranged to couple or mate with an edge connector of device 122-8. In an example where connector 123-8 is arranged according to SFF-TA-1002 in order to couple with device 122-8, a first pinout arrangement of socket connector 123-8 can follow or is based on an SFF-TA-1002 pinout and a second pinout arrangement of socket connector 123-5 can be arranged to mirror the pinout arrangement of socket connector 125-8 for at least Rx/Tx data channels included in signal channels 240. With such an arrangement, socket connectors 123-8 and 125-8 can be aligned in a way to allow for this mirrored pinout arrangement for at least the Rx/Tx data channels included in signal channels 240 through HSBP 124 and directly connect respective Rx/Tx data channels through respective single through-hole vias between socket connectors 123-8 and 125-8. The single through-hole vias can be based on regular via technology or using via in pad plated over (VIPPO) technology. This direct, mirrored connection between socket connectors substantially reduces or removes a need to route PCB traces within HSBP 124 and also reduces a number of via transitions from two (when socket connectors are not aligned and need PCB traces) to one for each Tx/Rx data signal channel. The reduced or no need to add internal layers to route PCB traces within HSBP 124 also allows for avoidance of via back drill technologies or using expensive PCB materials to reduce signal integrity losses caused when internal layers are used to route PCB traces between unaligned or non-mirrored pinout arrangement for socket connectors.

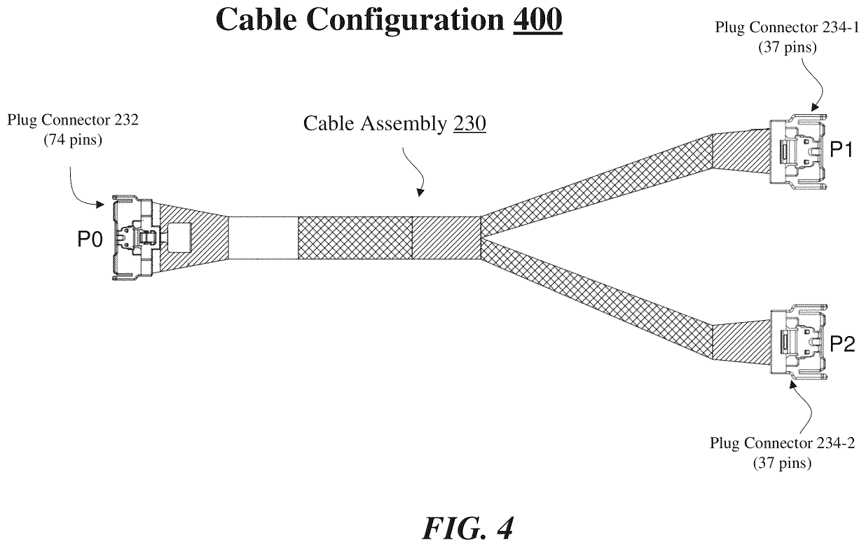

FIG. 4 illustrates example cable configuration 400. According to some examples, as shown in FIG. 4, cable configuration 400 can include cable assembly 230 with 1 plug connector 232 (P0) having 74 pins and 2 plug connectors 234-1 (P1) and 234-2 (P2) each having 37 pins. In one example, cable assembly 230 can have plug connector 232 (P0) configured as a 8x4 mini cool edge input/output (MCIO) plug connector that receives 8 Rx/Tx signal channels through 74 pins and splits those 8 Rx/Tx signal channels between plug connectors 234-1 (P1) and 234-2 (P2) each having 37 pins. Plug connector 232 can be arranged according to the SFF-TA-1016 specification. On the other side of cable assembly 230, although configured in a same form factor as an SFF-TA-1016 plug connector, signal wires or cables for 4 Rx/Tx data signal channels terminated at pins in plug connectors 234-1 and 234-2 can electrically couple with pins in socket connectors such as socket connector 125-8 that mirrors pins for 4 Rx/Tx data signal channels routed through HSBP 124 to a socket connector arranged to receive or couple with a device such as socket connector 123-8 arranged to couple with device 122-8. Socket connector 125-8 to receive, couple or mate with plug connectors 234-1 or 234-2 can be in a same form factor as an SFF-TA-1016 socket connector. Meanwhile, socket connector 125-8 can be in a same form factor as an SFF-TA-1002/1020 socket connector. Due to this mirroring of data signal channel pins for different types of SFF-TA connectors on the HSBP side of cable assembly 230, plug connector 232 can have an asymmetrical pin configuration to plug connectors 234-1 and 234-2 for cable assembly 230. An example cable Rx/Tx data signal pinout for 4 Rx/Tx data signal channels/wires routed between plug connectors of a cable assembly such as between plug connector 232 and plug connector 234-1 is described in more details below.

Examples are not limited to a 8 to 4 Rx/Tx cable configuration as described above for cable configuration 400. For example, the full 8 Rx/Tx data signal channels could be routed through cable assembly 230 to a single plug connector 234 to couple with a socket connector on HSBP 124. Alternatively, the 8 Rx/Tx data signal channels can be split amongst 4 different plug connectors and routed to those 4 different plug connectors to couple with respective 4 socket connectors on HSBP 124. Also, examples are not limited to 8 Rx/Tx data signal channels being received at plug connector 232. More or less Rx/Tx data signal channels can be received at plug connector 232.

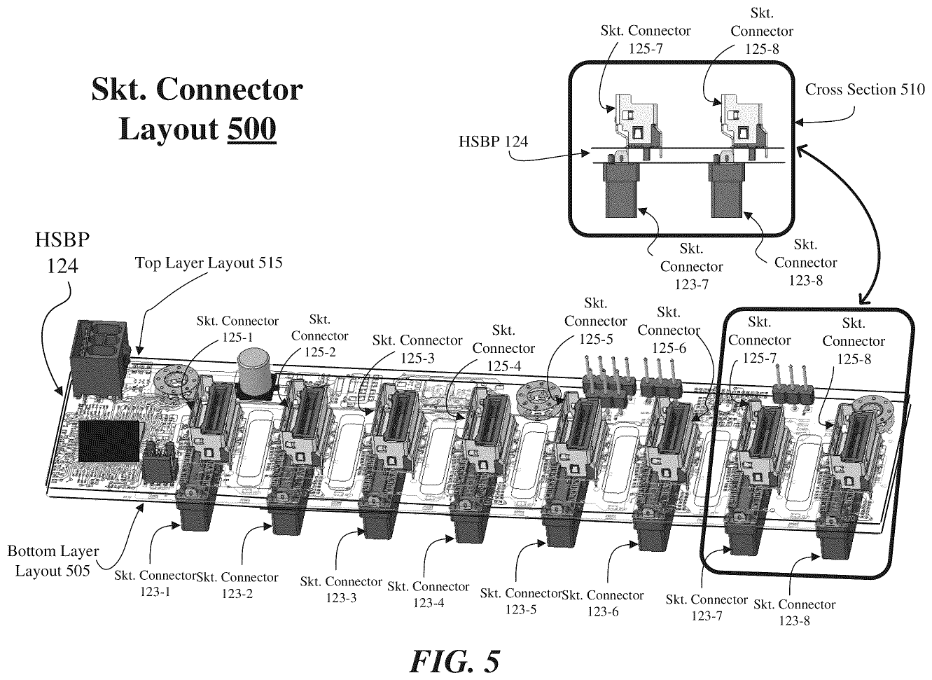

FIG. 5 illustrates an example socket connector layout 500. In some examples, as shown in FIG. 5, socket connector layout 500 shows a top layer layout 515 of HSBP 124 that includes socket connectors 125-1 to 125-8 and a bottom layer 505 of HSBP 124 that includes socket connectors 123-1 and 123-8. Also, FIG. 5 includes a cross section 510 that shows a cross section view to depict an example alignment of socket connector 125-7 with socket connector 123-7 and an example alignment of socket connector 125-8 with socket connector 123-8. In one example, socket connectors 123-7 and 123-8 can be configured such that Rx/Tx data signal channels to be routed through socket connectors 123-7 and 123-8 (e.g., to/from devices 122-7 and 122-8) are aligned to mirror Rx/Tx data signal channels to be routed through socket connectors 125-7 and 125-8 (e.g., to/from CPU 201 and routed through cable assembly 230). For this example, connectors 125-7 and 125-8 can be in a same form factor as an SFF-TA-1016 socket connector and socket connectors 125-7 and 125-8 can be in a same form factors as an SFF-TA-1002/1020 socket connector. An example socket pinout arrangement for 4 Rx/Tx data signal channels routed between socket connectors on either side of HSBP 124 is described in more details below.

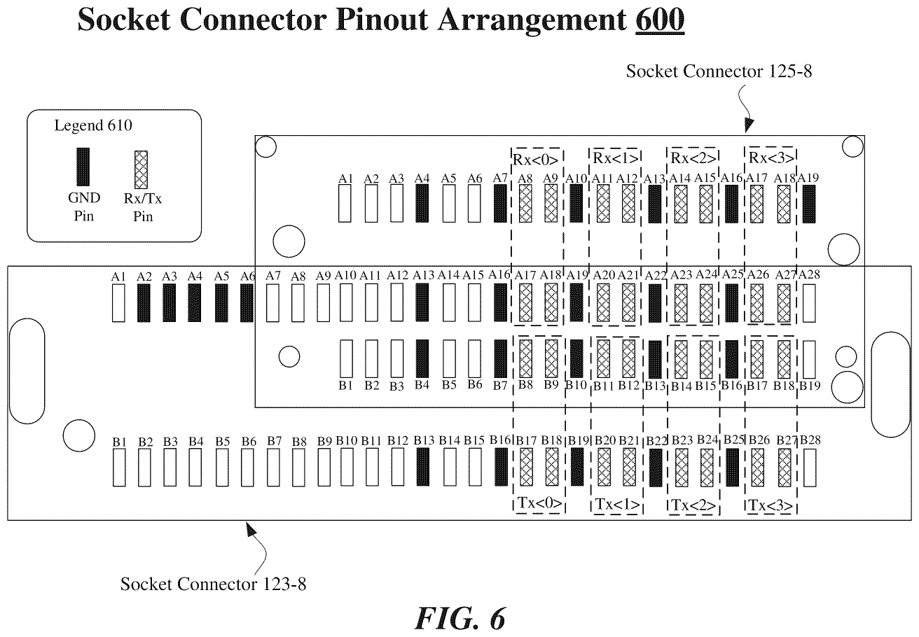

FIG. 6 illustrates an example socket connector pinout arrangement 600. In some examples, socket connector pinout arrangement 600 shows an example of how pins for socket connector 123-8 and socket connector 125-8 can be aligned on HSBP 124. For these examples, HSBP 124 is not shown and socket connectors 123-8 and 125-8 are depicted as if HSBP 124 was transparent. In one example, socket connector 125-8 can have a form factor of a 38 pin SFF-TA-1016 socket connector and socket connector 125-8 can have a form factor of a 56 pin SFF-TA-1002/1020 socket connector arranged to receive an EDSFF device (e.g., an EDSFF SSD). Also, for the example socket connector pinout arrangement 600, a bottom layer of socket connector 125-8 and a top layer of socket connector 123-8 is shown in FIG. 6. In other words, the view of this arrangement would be from a perspective of a device being inserted in socket connector 123-8, if HSBP 124 was transparent.

According to some examples, at least a portion of the 38 pins included in socket connector 125-8 can be arranged such that pins to route Rx/Tx data signal channels (e.g., included in signal channels 240) are mirrored as shown in FIG. 6. For example, pins labeled as A8/A9, A11/A12, A14/A15 and A17/A18 of socket connector 125-8 that route respective Rx data signal channels Rx<0>, Rx<1>, Rx<2> and Rx<3> can mirror pins labeled as A17/A18, A20/A21, A23/A24 and A26/A27 of socket connector 123-8 that route the same respective Rx data signal channels of Rx<0>, Rx<1>, Rx<2> and Rx<3>. Also pins labeled as B8/B9, B11/B12, B14/B15 and B17/B18 of socket connector 125-8 that route respective Tx data signal channels Tx<0>, Tx<1>, Tx<2> and Tx<3> can mirror pins labeled as B17/B18, B20/B21, B23/B24 and B26/B27 of socket connector 123-8 that route the same respective Tx data signal channels of Tx<0>, Tx<1>, Tx<2> and Tx<3>. Ground pins located between Rx or Tx signal channels can reduce possible cross talk or interference between Rx or Tx data signal channels or other types of signal channels. For simplicity purposes, only pins for Rx/Tx data signal channels and ground pins are shown in FIG. 6 for socket connectors 123-8 and 125-8.

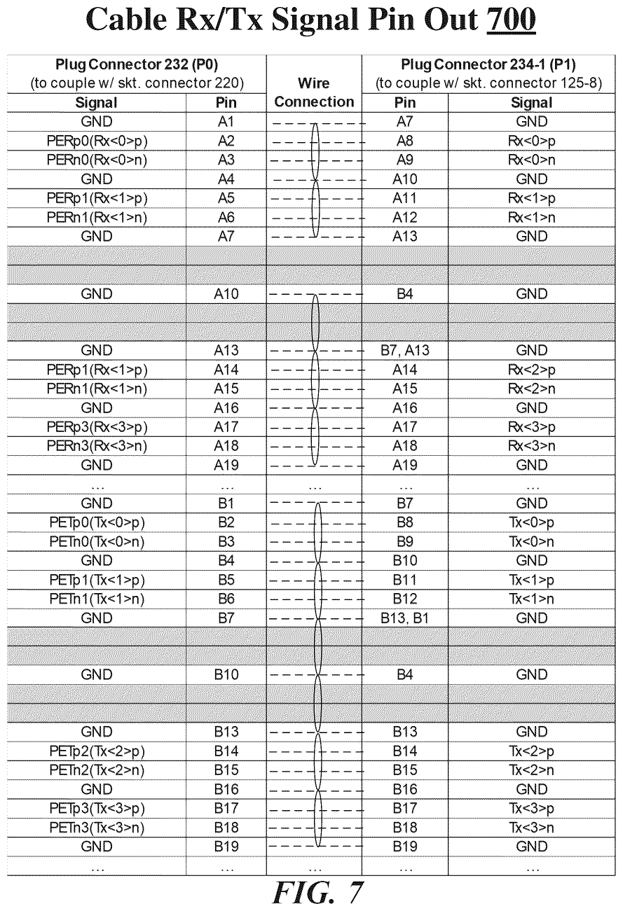

FIG. 7 illustrates an example cable Rx/Tx signal pinout 700. According to some examples, as shown in FIG. 7, cable Rx/Tx signal pinout 700 shows an example of how 4 Rx/Tx data signal channels can be routed through cable/signal wires within cable assembly 230 that includes plug connector 232 and plug connector 234-1 as mentioned above for cable configuration 400.

In some examples, pin-to-signal assignments for plug connector 234-1 are arranged to mate or couple with pins of socket connector 125-8 as mentioned above for socket connector pinout arrangement 600 shown in FIG. 6. For example, pins A8/A9, A11/A12, A14/A15 and A17/A18 of socket connector 125-8 for data signal channels Rx<0>, Rx<1>, Rx<2> and Rx<3> are to couple with pins A8/A9, A11/A12, A14/A15 and A17/A18 when plug connector 234-1 is coupled with socket connector 125-8. Also, pins B8/B9, B11/B12, B14/B15 and B17/B18 of socket connector 125-8 for data signal channels Tx<0>, Tx<1>, Tx<2> and Tx<3> are to couple with pins B8/B9, B11/B12, B14/B15 and B17/B18 when plug connector 234-1 couples with socket connector 125-8. For these examples, the pin labels for plug connector 232 do not match the pin labels for plug connector 234-1 can indicate plug connector 232 has an asymmetrical pin configuration compared to plug connector 234-1. The asymmetrical pin configuration can be due to an attempt to enable Rx/Tx data signals at plug connector 234-1 to couple with pins at socket connector 125-8 that mirror Rx/Tx data signal pins at socket connector 123-8. The mirroring of Rx/Tx data signal pins can, as mentioned above, enable these socket connectors to directly connect individual Rx/Tx data signals through respective single through-hole vias of HSBP 124.

Although not shown in FIG. 7, another 4 Tx/Rx data signal channels can be routed through cable/signal wires within cable assembly 230 that includes the second plug connector 234-2 shown in FIG. 4. For the example cable Rx/Tx signal pinout 700 shown in FIG. 7, the 37 pins of plug connector 232 routed to the second plug connector 234-2 is not shown for simplicity purposes. However, a similar wire connection scheme is contemplated for pins A20-A37 and B20-B37 of plug connector 232 (these pins are not shown in FIG. 7) for routing 4 Tx/Rx data signal channels to the second plug connector 234-2 pins through cable/signal wires within cable assembly 230.

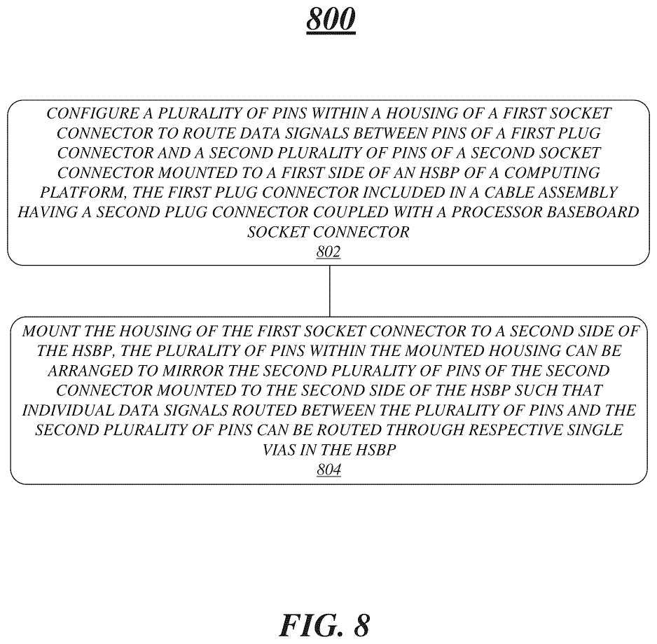

FIG. 8 illustrates an example logic flow 800. According to some examples, logic flow 800 describes configuration of pins within a housing of a first socket connector that can be mounted to an HSBP of a computing platform such as socket connector from among socket connectors 125-1 to 125-8 to be mounted to HSBP 124 of computing platform 100 as described above for FIGS. 1-3 and 5-6.

In some examples, at 802, the logic flow 800 can configure a plurality of pins within a housing of a first socket connector to route data signals between pins of a first plug connector and a second plurality of pins of a second socket connector mounted to a first side of an host HSBP of a computing platform, the first plug connector included in a cable assembly having a second plug connector coupled with a processor baseboard socket connector. For these examples, the first socket connector can be socket connector 125-8 that includes the Rx/TX data signal pins depicted in FIG. 6 for socket connector pinout arrangement 600 and the second socket connector can be socket connector 123-8 that is mounted to a first side of HSBP 124. Also, the first plug connector included in the cable assembly can be plug connector 234-1 of cable assembly 230 having a pinout as shown in FIG. 7 for cable Rx/Tx signal pinout 700.

According to some examples, at 804, logic flow 800 can mount the housing of the first socket connector to a second side of the HSBP, the plurality of pins within the mounted housing can be arranged to mirror the second plurality of pins of the second connector mounted to the first side of the HSBP such that individual data signals routed between the plurality of pins and the second plurality of pins can be routed through respective single vias in the HSBP. For these examples, the housing of socket connector 125-8 can be mounted to the second side of HSBP 124 and the Rx/Tx data signal pins of socket connector 125-8 depicted in FIG. 6 for socket connector pinout arrangement 600 can be arranged to mirror the Rx/Tx data signal pins of socket connector 123-8 such that individual data signals can be routed through respective single vias in HSBP 124. In other words, no PCB trace routing is needed through HSBP 124 due to this mirrored arrangement of Rx/Tx data signal pins.

Embodiments herein may be implemented in various types of computing and networking equipment, such as switches, routers, racks, and blade servers such as those employed in a data center and/or server farm environment. The servers used in data centers and server farms can include arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled” or “coupled with”, however, may also mean that two or more elements are not in direct contact with each other, but yet still co-operate or interact with each other.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

The follow examples pertain to additional examples of technologies disclosed herein.

Example 1. An example socket connector can include a housing configured to be mounted to a first side of an HSBP of a computing platform. The housing can be in a form factor configured to receive a first plug connector of a cable assembly having a second plug connector coupled with a processor baseboard socket connector. The socket connector can also include a plurality of pins within the housing configured to route data signals between pins of the first plug connector and a second plurality of pins of a second socket connector mounted to a second side of the HSBP. The plurality of pins can mirror the second plurality of pins such that individual data signals routed between the plurality of pins and the second plurality of pins are routed through respective single vias in the HSBP.

Example 2. The socket connector of example 1, the second socket connector mounted to the second side of the HSBP can be configured to receive a connector edge of a device and the second plurality of pins are configured to route the data signals to or from the connector edge of the device.

Example 3. The socket connector of example 2, the device can be a memory device, a GPU accelerator device, or a processor accelerator device.

Example 4. The socket connector of example 2, the device can be a memory device configured as an SSD in an enterprise and data center SDD form factor (EDSFF).

Example 5. The socket connector of example 4, the housing in the form factor configured to receive the first plug connector of the cable assembly can include the form factor configured according to an SFF-TA specification to include SFF-TA-1016 and the second socket connector on the second side of the HSBP can be configured according to a second SFF-TA specification to include SFF-TA-1002. For this example, a pinout of the plurality of pins within the housing can cause the plurality of pins within the housing to mirror the second plurality of pins based on an SFF-TA-1002 pinout for the second plurality of pins.

Example 6. The socket connector of example 5, a form factor of the first plug connector of the cable assembly can be configured according to SFF-TA-1016 and a pinout of pins in the first plug connector are based on the pinout of the plurality of pins within the housing. For this example, a form factor of the second plug connector of the cable assembly can be configured according to SFF-TA-1016 and a pinout of pins in the second plug connector can be based on an SFF-TA-1016 pinout.

Example 7. The socket connector of example 1, the HSBP can include a PCB. The housing can be mounted to the first side of the HSBP using SMT and the second socket connector can be mounted to the second side of the HSBP using SMT. For this example, the plurality of pins within the housing can mirror the second plurality of pins such that individual data signals routed between the plurality of pins and the second plurality of pins are routed through respective single vias in the PCB without using PCB trace routing.

Example 8. An example method can include configuring a plurality of pins within a housing of a first socket connector to route data signals between pins of a first plug connector and a second plurality of pins of a second socket connector mounted to a first side of an HSBP of a computing platform. The first plug connector can be included in a cable assembly having a second plug connector coupled with a processor baseboard socket connector. The method can also include mounting the housing of the first socket connector to a second side of the HSBP. The plurality of pins within the mounted housing can be arranged to mirror the second plurality of pins of the second socket connector mounted to the first side of the HSBP such that individual data signals routed between the plurality of pins and the second plurality of pins can be routed through respective single vias in the HSBP.

Example 9. The method of example 8, the second socket connector mounted to the first side of the HSBP can be configured to receive a connector edge of a device and the second plurality of pins are configured to route the data signals to or from the connector edge of the device.

Example 10. The method of example 9, the device can be a memory device, a GPU accelerator device, or a processor accelerator device.

Example 11. The method of example 9, the device can be a memory device configured as an SSD in an enterprise and data center SDD form factor (EDSFF).

Example 12. The method of example 11, the housing can be in a form factor configured to receive the first plug connector of the cable assembly, the housing form factor based on an SFF-TA specification to include SFF-TA-1016 and the second socket connector on the first side of the HSBP can be configured based on a second SFF-TA specification to include SFF-TA-1002. For this example, a pinout of the plurality of pins within the housing can cause the plurality of pins within the housing to mirror the second plurality of pins based on an SFF-TA-1002 pinout for the second plurality of pins.

Example 13. The method of example 12, a form factor of the first plug connector of the cable assembly can be configured based on SFF-TA-1016 and a pinout of pins in the first plug connector can be based on the pinout of the plurality of pins within the housing. For this example, a form factor of the second plug connector of the cable assembly can configured based on SFF-TA-1016 and a pinout of pins in the second plug connector can be based on an SFF-TA-1016 pinout.

Example 14. The method of example 8, the HSBP can include a PCB. Mounting the housing of the first socket connector to the second side of the HSBP can include using SMT and the second socket connector can be mounted to the first side of the HSBP using SMT. The plurality of pins can mirror the second plurality of pins such that individual data signals routed between the plurality of pins and the second plurality of pins can be routed through respective single vias in the PCB without using PCB trace routing.

Example 15. An example system can include a cable assembly having a first plug connector and a second plug connector. The system can also include a first socket connector that includes a housing configured to be mounted to a first side of an HSBP of a computing platform. The housing can be in a form factor configured to receive the first plug connector of the cable assembly. The first socket connector can also include a plurality of pins within the housing configured to route data signals between pins of the first plug connector and a second plurality of pins of second socket connector mounted to a second side of the HSBP. The plurality of pins can mirror the second plurality of pins such that individual data signals routed between the plurality of pins and the second plurality of pins can be routed through respective single vias in the HSBP.

Example 16. The system of example 15, the second socket connector mounted to the second side of the HSBP can be configured to receive a connector edge of a device and the second plurality of pins can be configured to route the data signals to or from the connector edge of the device.

Example 17. The system of example 16, the device can be a memory device, a GPU accelerator device, or a processor accelerator device.

Example 18. The system of example 16, the device can be a memory device configured as an SSD in an enterprise and data center SDD form factor (EDSFF).

Example 19. The system of example 18, the housing in the form factor configured to receive the first plug connector of the cable assembly can include the form factor configured according to an SFF-TA specification to include SFF-TA-1016 and the second socket connector on the second side of the HSBP can be configured according to a second SFF-TA specification to include SFF-TA-1002. A pinout of the plurality of pins within the housing can cause the plurality of pins within the housing to mirror the second plurality of pins based on an SFF-TA-1002 pinout for the second plurality of pins.

Example 20. The system of example 19, a form factor of the first plug connector of the cable assembly can be configured according to SFF-TA-1016 and a pinout of pins in the first plug connector can be based on the pinout of the plurality of pins within the housing. For this example a form factor of the second plug connector of the cable assembly can be configured according to SFF-TA-1016 and a pinout of pins in the second plug connector can be based on an SFF-TA-1016 pinout.

Example 21. The system of example 15, the HSBP includes a PCB, the housing of the first socket connector can be mounted to the first side of the HSBP using SMT and the second socket connector can be mounted to the second side of the HSBP using SMT. For this example, the plurality of pins within the housing can mirror the second plurality of pins such that individual data signals routed between the plurality of pins and the second plurality of pins can be routed through respective single vias in the PCB without using PCB trace routing.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A socket connector comprising:
a housing configured to be mounted to a first side of a hot swap backplane (HSBP) of a computing platform, the housing in a form factor configured to receive a first plug connector of a cable assembly having a second plug connector coupled with a processor baseboard socket connector; and
a plurality of pins within the housing configured to route data signals between pins of the first plug connector and a second plurality of pins of a second socket connector mounted to a second side of the HSBP, wherein the plurality of pins mirror the second plurality of pins such that individual data signals routed between the plurality of pins and the second plurality of pins are routed through respective single vias in the HSBP.

2. The socket connector of claim 1, wherein the second socket connector mounted to the second side of the HSBP is configured to receive a connector edge of a device and the second plurality of pins are configured to route the data signals to or from the connector edge of the device.

3. The socket connector of claim 2, wherein the device comprises a memory device, a graphics processing unit (GPU) accelerator device, or a processor accelerator device.

4. The socket connector of claim 2, wherein the device comprises a memory device configured as a solid state drive (SSD) in an enterprise and data center SDD form factor (EDSFF).

5. The socket connector of claim 4, wherein the housing in the form factor configured to receive the first plug connector of the cable assembly comprises the form factor configured according to a Small Form Factor—Technology Affiliate (SFF-TA) specification to include SFF-TA-1016 and the second socket connector on the second side of the HSBP is configured according to a second SFF-TA specification to include SFF-TA-1002, and wherein a pinout of the plurality of pins within the housing is to cause the plurality of pins within the housing to mirror the second plurality of pins based on an SFF-TA-1002 pinout for the second plurality of pins.

6. The socket connector of claim 5, wherein a form factor of the first plug connector of the cable assembly is configured according to SFF-TA-1016 and a pinout of pins in the first plug connector are based on the pinout of the plurality of pins within the housing, and wherein a form factor of the second plug connector of the cable assembly is configured according to SFF-TA-1016 and a pinout of pins in the second plug connector are based on an SFF-TA-1016 pinout.

7. The socket connector of claim 1, wherein the HSBP includes a printed circuit board (PCB), the housing is to be mounted to the first side of the HSBP using surface mount technology (SMT) and the second socket connector is to be mounted to the second side of the HSBP using SMT, and wherein the plurality of pins within the housing mirror the second plurality of pins such that individual data signals routed between the plurality of pins and the second plurality of pins are routed through respective single vias in the PCB without using PCB trace routing.

8. A method comprising:
configuring a plurality of pins within a housing of a first socket connector to route data signals between pins of a first plug connector and a second plurality of pins of a second socket connector mounted to a first side of a host swap backplane (HSBP) of a computing platform, the first plug connector included in a cable assembly having a second plug connector coupled with a processor baseboard socket connector; and
mounting the housing of the first socket connector to a second side of the HSBP, wherein the plurality of pins within the mounted housing are arranged to mirror the second plurality of pins of the second socket connector mounted to the first side of the HSBP such that individual data signals routed between the plurality of pins and the second plurality of pins are routed through respective single vias in the HSBP.

9. The method of claim 8, wherein the second socket connector mounted to the first side of the HSBP is configured to receive a connector edge of a device and the second plurality of pins are configured to route the data signals to or from the connector edge of the device.

10. The method of claim 9, wherein the device comprises a memory device configured as a solid state drive (SSD) in an enterprise and data center SDD form factor (EDSFF).

11. The method of claim 10, wherein the housing is in a form factor configured to receive the first plug connector of the cable assembly, the housing form factor based on a Small Form Factor—Technology Affiliate (SFF-TA) specification to include SFF-TA-1016 and the second socket connector on the first side of the HSBP is configured based on a second SFF-TA specification to include SFF-TA-1002, and wherein a pinout of the plurality of pins within the housing is to cause the plurality of pins within the housing to mirror the second plurality of pins based on an SFF-TA-1002 pinout for the second plurality of pins.

12. The method of claim 11, wherein a form factor of the first plug connector of the cable assembly is configured based on SFF-TA-1016 and a pinout of pins in the first plug connector are based on the pinout of the plurality of pins within the housing, and wherein a form factor of the second plug connector of the cable assembly is configured based on SFF-TA-1016 and a pinout of pins in the second plug connector are based on an SFF-TA-1016 pinout.

13. The method of claim 8, wherein the HSBP includes a printed circuit board (PCB), and wherein mounting the housing of the first socket connector to the second side of the HSBP includes using surface mount technology (SMT) and the second socket connector is to be mounted to the first side of the HSBP using SMT, and wherein the plurality of pins mirror the second plurality of pins such that individual data signals routed between the plurality of pins and the second plurality of pins are routed through respective single vias in the PCB without using PCB trace routing.

14. A system comprising:
a cable assembly having a first plug connector and a second plug connector; and
a first socket connector that includes:
a housing configured to be mounted to a first side of a hot swap backplane (HSBP) of a computing platform, the housing in a form factor configured to receive the first plug connector of the cable assembly; and
a plurality of pins within the housing configured to route data signals between pins of the first plug connector and a second plurality of pins of second socket connector mounted to a second side of the HSBP, wherein the plurality of pins mirror the second plurality of pins such that individual data signals routed between the plurality of pins and the second plurality of pins are routed through respective single vias in the HSBP.

15. The system of claim 14, wherein the second socket connector mounted to the second side of the HSBP is configured to receive a connector edge of a device and the second plurality of pins are configured to route the data signals to or from the connector edge of the device.

16. The system of claim 15, wherein the device comprises a memory device, a graphics processing unit (GPU) accelerator device, or a processor accelerator device.

17. The system of claim 15, wherein the device comprises a memory device configured as a solid state drive (SSD) in an enterprise and data center SDD form factor (EDSFF).

18. The system of claim 17, wherein the housing in the form factor configured to receive the first plug connector of the cable assembly comprises the form factor configured according to a Small Form Factor—Technology Affiliate (SFF-TA) specification to include SFF-TA-1016 and the second socket connector on the second side of the HSBP is configured according to a second SFF-TA specification to include SFF-TA-1002, and wherein a pinout of the plurality of pins within the housing is to cause the plurality of pins within the housing to mirror the second plurality of pins based on an SFF-TA-1002 pinout for the second plurality of pins.

19. The system of claim 18, wherein a form factor of the first plug connector of the cable assembly is configured according to SFF-TA-1016 and a pinout of pins in the first plug connector are based on the pinout of the plurality of pins within the housing, and wherein a form factor of the second plug connector of the cable assembly is configured according to SFF-TA-1016 and a pinout of pins in the second plug connector are based on an SFF-TA-1016 pinout.

20. The system of claim 14, wherein the HSBP includes a printed circuit board (PCB), the housing of the first socket connector is to be mounted to the first side of the HSBP using surface mount technology (SMT) and the second socket connector to be mounted to the second side of the HSBP using SMT, and wherein the plurality of pins within the housing mirror the second plurality of pins such that individual data signals routed between the plurality of pins and the second plurality of pins are routed through respective single vias in the PCB without using PCB trace routing.
